(19) United States
(12) Patent Application Publication
(10) Pub. No.: US 2004/0117372 A1
(43) Pub. Date: Jun. 17, 2004

(54) System and method for controlling access to system resources

(76) Inventor: Bulent Kasman, Antoich, CA (US)

Correspondence Address: Fay Kaplun & Marcin, LLP, Suite 702, 150 Broadway, New York, NY, 10038, US

(21) Appl. No.: 10/321,909

(22) Filed: Dec. 17, 2002

(51) Int. Cl. G06F 17/30

(52) U.S. Cl. 707/9

(57) ABSTRACT

A method, comprising the steps of identifying a path of resources, wherein a last resource in the path is to be accessed, placing a first lock type on each of the resources in the path except the last resource, and placing a second lock type on the last resource.

### BACKGROUND INFORMATION

Modern electronic devices make intensive use of data generated by the devices themselves or by other devices connected to them. These devices are not limited to computers, but include a variety of much simpler devices that have reduced computing capabilities and capacity to connect with other devices. A personal computer (“PC”) or server is generally regarded as a traditional computing device, but other computing devices such as embedded devices (e.g., personal digital assistants (“PDAs”), mobile phones, routers, switches, etc.) may also be included as part of a computer network.

The functions performed by these devices can be broken down into functions that are carried out by different modules, which can include different software components or applications being executed by the device. The modules can be used in the overall operation of the device, or may be associated with a specific element or function of the device, such as operating a web server or a display. The software components are each programmed to perform some specific function, and may require information from other components to perform that function and/or may produce information that is needed by other components. The data or function carried out by a component and used by another component is commonly called a resource.

The data transfer between components must be managed and streamlined. In particular, when a component (the consumer) requires data from a resource of another component (the producer), the data request must be correlated with the correct resource, so that the consumer can retrieve the data. This process should be rapid, and require a minimal amount of overhead computational resources from the software component, and from the device as a whole. In some cases, the software components may be physically located on different devices, which are interconnected by a data transfer network.

The function of correlating requests from consumers with resources of the producers is typically carried out by one or more backplane modules. The backplane provides an interface between applications that are resource consumers and applications that are resource producers. The backplane thus is a central element to which are connected a multitude of producers and consumers, such that the backplane can route the requests for data to the correct resource, and return the data to the correct consumer. Multiple consumers may attempt to simultaneously access one or more of the producer resources. There should be a manner to control access to the system resources.

### SUMMARY OF THE INVENTION

A method, comprising the steps of identifying a path of resources, wherein a last resource in the path is to be accessed, placing a first lock type on each of the resources in the path except the last resource, and placing a second lock type on the last resource.

Furthermore, a system, comprising a transaction manager configured to manage access to a first resource and a lock manager configured to lock a set of resources, the set of resources including the first resource and parent resources of the first resource, wherein the lock manager is configured to place a first lock type on the parent resources and a second lock type on the first resource.

In addition, a system, comprising an object including data which can be accessed by a consumer component, wherein the access by the consumer component is one of a read operation and a write operation, a handler responsible for the object, and a backplane receiving a request from the consumer component to access the object, wherein, prior to allowing access to the object, a first lock type is placed on the backplane and the handler and a second lock type is placed on the object.

### BRIEF DESCRIPTION OF DRAWINGS

FIG. 1 shows an exemplary system on which an exemplary embodiment of the present invention may be implemented;

FIG. 2 shows a second exemplary system implementing resource locks according to the present invention;

FIG. 3 shows an exemplary process for locking a resource according to the present invention;

FIG. 4 shows exemplary subset of the second exemplary system including exemplary data structures for the resource locks according to the present invention.

### DETAILED DESCRIPTION

The present invention may be further understood with reference to the following description and the appended drawings, wherein like elements are provided with the same reference numerals. The exemplary embodiment may be described as being implemented on a computing device and this should be understood to mean any computing and/or electronic device including a processor and/or microprocessor, for example, PCs, servers, internet devices, embedded devices, or any computing device and the term device will be used to generally describe such devices. In addition, throughout this description the terms components, modules and resources are variously used to describe the same elements within a system. When reading this description, these terms should be considered coextensive.

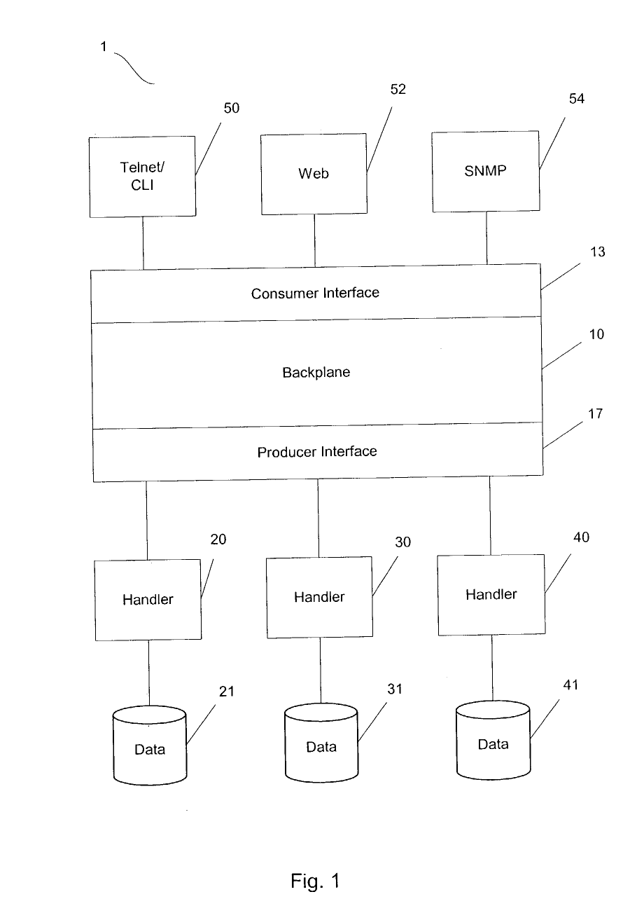

FIG. 1 shows an exemplary system 1 on which an exemplary embodiment of the present invention may be implemented. The system 1 includes a Telnet/Command Line Interface (“CLI”) module 50, a web browser module 52 and a Simple Network Management Protocol (“SNMP”) module 54. Each of the modules 50-54 may be considered consumer components, i.e., components which request data from a resource of another component. The interaction between the consumer component and the data may involve more than a request for the data (e.g., a get request). Other interactions may include, for example, the setting of a value (e.g., a set request) in the resource by the consumer component (e.g., modules 50-54), the insertion of a new component on the producer side, the replacement of an existing component on the producer side, etc. Thus, throughout this description where it is described that the consumer components are requesting data (or accessing a resource), this is meant to describe any interaction between the consumer component and the data and/or producer component, not merely a get request.

The system 1 also includes a backplane 10 which may also include a consumer interface 13 for the backplane 10 to interact with the consumer components (e.g., components 50-54) and a producer interface 17 for backplane 10 to interact with the producer components (e.g., components 20-40). Those of skill in the art will understand that the backplane 10 may include any number of other modules or components, some of which will be described in greater detail below. Additional components that may be included in the backplane 10, but are not described herein may not be necessary for the understanding of the exemplary embodiment of the present invention.

The other components from which the data is requested are producer components. In the exemplary system 1, handler modules 20-40 may be considered producer components. Each of the handler modules 20-40 may have an associated data storage module 21-41, respectively. The data storage modules 21-41 may include, for example, data objects for which the handler modules 20-40 are the responsible producer components. The data requested by the consumer components (e.g., modules 50-54) may include these data objects. Those of skill in the art will understand that the system 1 is only exemplary and that the present invention may be implemented on any system where multiple components may attempt to access resources within the system.

In the system 1, a consumer component may request access to data controlled by a producer component. For example, the SNMP module 54 may request access to a data object in the data storage module 31 controlled by the handler 30. The SNMP module 54 will communicate this request via the consumer interface 13 to the backplane 10. The request will then be directed by the backplane 10 to the correct producer component (i.e., the handler 30) via the producer interface 17. The handler 30 will access the data object on the data storage module 31 and the appropriate action will be taken for the data object (e.g., get, set, etc.).

However, while the SNMP module 54 is accessing the data object in the data storage module 31, the Telnet/CLI module 50 may request access to the same data object. In some instances, the system 1 should allow the Telnet/CLI module 50 to simultaneously access the same data object (e.g., when the SNMP module 54 is reading the data object without making any changes to the data object). In other instances, the system 1 should prevent the Telnet/CLI module 50 from simultaneously accessing the same data object, i.e., the data object should be isolated (e.g., when the SNMP module 54 is setting a value in the data object). The exemplary embodiment of the present invention allows for multiple transactions to execute in parallel without violating the isolation principle. Thus, the exemplary embodiment of the present invention allows for isolated transactions in a multi-tasking environment.

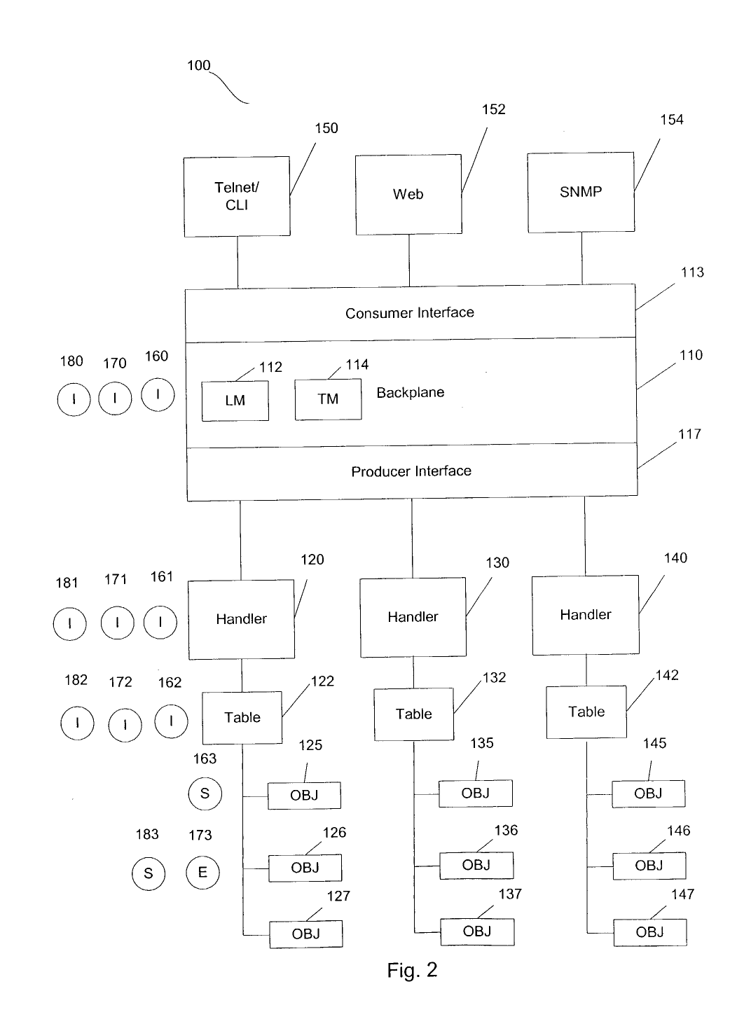

FIG. 2 shows a second exemplary system 100 implementing resource locks according to an exemplary embodiment of the present invention. The system 100 includes additional details that are not shown in the system 1 of FIG. 1. The system 100 shows the components arranged in a hierarchical manner. In particular, there is a distinct hierarchical path leading from the backplane 110 and culminating with each of the data objects. The first level beneath the backplane 110 are the handlers 120-140 which are the producer components which own the data objects. The tables 122, 132 and 142 are a level below the handlers 120, 130 and 140, respectively. The tables 122-142 may contain one or more data objects. In this example, each table includes three data objects, the table 122 includes data objects 125-127, the table 135 includes data objects 135-137 and the table 142 includes data objects 145-147. Those of skill in the art will understand that the relationship between the system 1 of FIG. 1 and the system 100 of FIG. 2 maybe that the tables 122-142 and the data objects 125-127, 135-137 and 145-147 maybe stored in the data storage modules 21-41.

Otherwise, the system 100 operates in the same general manner as described above for the system 1. The consumer components 150-154 may request access to any of the producer components or the data controlled by the producer component, i.e., the consumer components 150-154 may request access to the data objects 125-127, 135-137, 145-147, tables 122-142 and/or handlers 120-140. Those of skill in the art will understand that such a hierarchical arrangement is only exemplary and that the present invention may be implemented on a system that does not implement the components in a hierarchical manner. As will be seen from the description below, if the backplane 110, or any similar component of a system, can discern the pathway (e.g., through a series of pointers maintained by the backplane, by a table, etc.) to the resource to be accessed, the exemplary locks of the present invention may be implemented in the system.

In the exemplary embodiment of system 100, the backplane 110 includes a lock manager 112 and a transaction manager 114. The lock manager 112 may be used to place the resource locks on the appropriate resource and the transaction manager 114 may be used to manage each of the transactions where a consumer component requests access to a producer component. Each of these components 112 and 114 will be described in greater detail below. Those of skill in the art will understand that the components 112 and 114 are examples of modules that may be included in the backplane 110, and that the lock manager 112 and the transaction manager 114 may be separate modules or may be included as sub-components of other modules.

FIG. 2 also shows representations of locks that may be placed on the components at the various levels. The actual lock on the component may be in the form of an entry in a data structure for the component and exemplary data structures will be described in greater detail below. In addition, a method for placing the locks on the various components will be described below. Initially, the type of locks shown in FIG. 2 will be described. The first type of lock is a shared (or read) lock as represented by shared lock 163 associated with data object 125. The shared lock 163 indicates that the resource is locked for a read operation. In this example, the data object 125 has been locked with shared lock 163 indicating that the data object 125 is being read, e.g., data object 125 is being read by the SNMP module 154. When a resource is locked with a shared lock (e.g., data object 125 having shared lock 163), the resource may still be available to be read by another component, e.g., web browser 152 may still access and read the data object 125 while the data object 125 is being read by the SNMP module 154. As will be described in greater detail below, in this example, the web browser 152 may also have to place a separate shared lock on the data object 125 in order to read that object.

The second type of lock is an exclusive (or write) lock as represented by the exclusive lock 173 associated with data object 126. The exclusive lock 173 indicates that the resource is locked for a write operation. In this example, the data object 126 has been locked with the exclusive lock 173 indicating that a write operation is being performed on the data object 126, e.g., a value of the data object 126 is being written by the SNMP module 154. When a resource is locked with an exclusive lock (e.g., data object 126 having exclusive lock 173), the resource is not available for another component to either read or write to that resource. For example, when the data object 126 has an exclusive lock 173 because the SNMP module 154 is writing to this resource, the Telnet/CLI module 150 may not access the data object 126 for either reading or writing purposes.

The final type of lock is an intent lock as represented by the intent lock 160 associated with the backplane 110. In the exemplary embodiment of the present invention, a lock will be placed on the resource that is going to be accessed by the consumer component. In addition, each of the parent resources of a resource that is going to be accessed will also be locked. The lock placed on the parent resources will be an intent lock. In the example of FIG. 2, the data object 125 has a shared lock 163. The parent resources of data object 125 are the table 122, the handler 120 and the backplane 110. Thus, each of these parent components will have a lock corresponding to the shared lock 163 for data object 125. In this example, the corresponding locks are intent lock 162 (the table 122), intent lock 161 (the handler 120), and intent lock 160 (the backplane 110). The intent lock indicates that one of the children of the component has a shared lock or an exclusive lock. Each of the locks including their operation and compatibility with other locks will be discussed in greater detail below.

Those of skill in the art will understand that the locks described above are only exemplary and not a complete list of all possible locks that may be used in a system. The present invention anticipates that a system designer may define any number of additional locks based on the functionality of an individual system. As will be described below, the exemplary locks each have a particular compatibility with the other exemplary locks. When a system designer creates new locks, the designer may define the compatibility and functionality of the new locks.

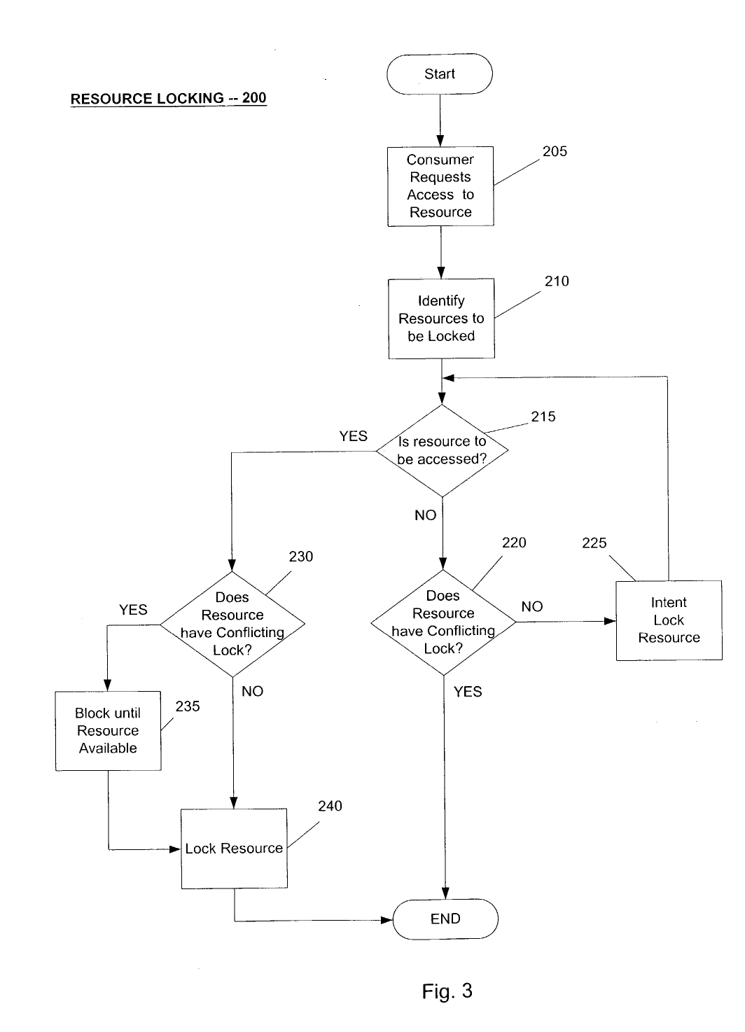

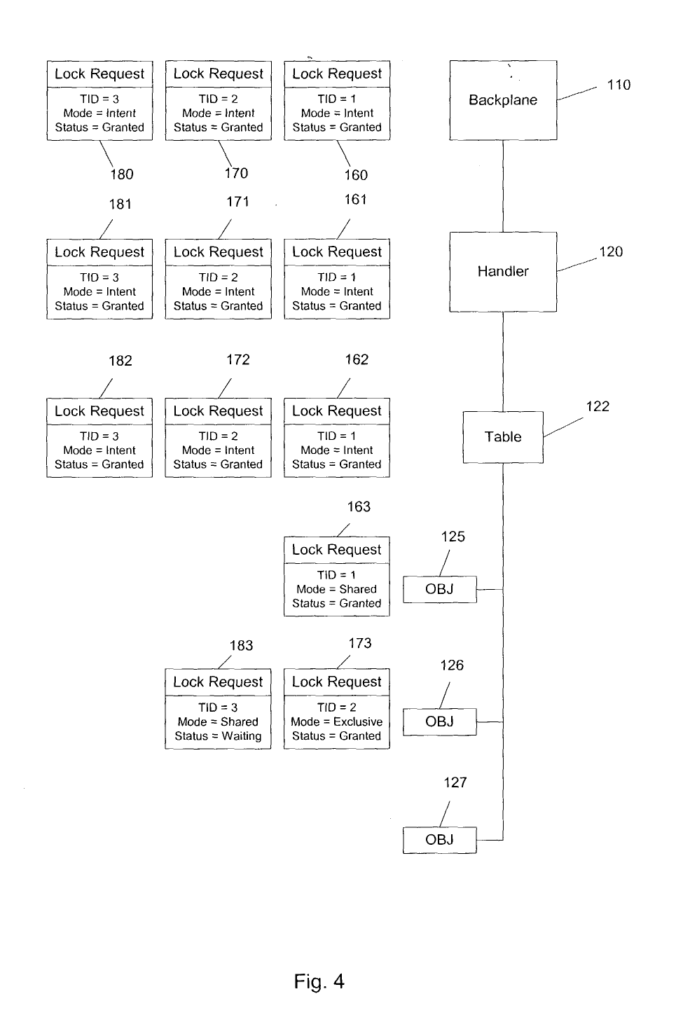

FIG. 3 shows an exemplary process 200 for locking a resource. The process 200 will be described with reference to FIGS. 2 and 4. FIG. 4 shows a subset of the system 100 of FIG. 2 which only includes the backplane 110, the handler 120, the table 122 and the data objects 125-127. As can be seen from FIG. 2, the subset shown in FIG. 4 is the hierarchical arrangement from the backplane 10 through the data objects 125-127. In addition, FIG. 4 shows exemplary data structures corresponding to the resource locks 160-163, 170-173 and 180-183 which are shown in FIG. 2. The exemplary data shown in the exemplary data structure will be described as the examples are carried through the process 200 of FIG. 3.

Starting with step 205, a consumer component requests access to a system resource, i.e., a producer component. The example that will initially be used to illustrate the process 200 is the SNMP module 154 requesting read access to the data object 125. The process 200 using this example will result in the intent locks 160, 161 and 162 being placed on the backplane 110, the handler 120 and the table 122, respectively and the shared lock 163 being placed on the data object 125. Thus, in referring to FIG. 2, it may be considered that initially, the locks 160-163, 170-173 and 180-183 are not present when the process 200 is initialized.

The request may be relayed through the consumer interface 113 to the transaction manager 114 of the backplane 110. The transaction manager 114 is responsible for the managing the access to the desired object (e.g., data object 125). Prior to allowing access to the data object 125, the transaction manager 114 notifies the lock manager 112 of the pending transaction. The lock manager 112 identifies the resources that need to be locked in order for the data object to be accessed (step 210).

Continuing with the example from above, the lock manager 112 will identify that the data object 125 resides in table 122, which is in the handler 120. In this manner, the lock manager identifies all the resources that need to be locked in order for the SNMP module 154 to access the data object 125. These resources include all the parent resources of the data object 125 from the backplane 110 down through the data object 125, i.e., the backplane 110, the handler 120, the table 122 and the data object 125. The lock manager 112 will then proceed to lock these resources in order for the SNMP module 154 to access the data object 125. The locking of the resources may occur from the top to the bottom, i.e., starting at the backplane 110 and going down through each child resource until the data object 125 is locked.

In step 215, the lock manager 112 determines whether the resource that it is locking is the resource to be accessed. For example, if the lock manager 112 started the locking operation at the backplane 110, the lock manager 112 would determine in step 215 that the backplane 110 is not the resource to be accessed because, in the example being described, the data object 125 is the resource to be accessed. Those of skill in the art will understand that a consumer component may desire to access any producer component from the backplane 110 through the data objects 125-127, 135-137, and 145-147. For example, a consumer component may desire to access the handler 140 or even the backplane 110. In addition, those of skill in the art will understand that the step 215 may be performed simultaneously for all resources in the hierarchy from the backplane 110 to the data object 125 at the time the lock manager 112 identifies the resources in step 210, i.e., when the lock manager 112 identifies the resources in the hierarchy, it may also determine which resource is to be accessed and which resources are the parents of that resource to be accessed.

If the lock manager 112 determines in step 215 that the resource it is locking is not the resource to be accessed, the process continues to step 220, where the lock manager 112 determines whether the resource has an existing lock which conflicts with the new lock the lock manager 112 is attempting to place on the resource. When the resource to be locked is not the resource to be accessed, an intent lock will be placed on the resource. As described above, an intent lock is placed on all the parent resources of the resource to be accessed. In this example, the backplane 110 is not the resource to be accessed (as determined in step 215). Thus, the lock manager 112 is attempting to place an intent lock on the backplane 110. The lock manager 112 will determine the other locks, if any, that are presently on the resource. If an existing lock conflicts with the intent lock that the lock manager 112 is attempting to place on the resource, the process 200 will end because the lock manager 112 may not place a conflicting lock on a presently locked resource.

Referring to FIG. 4, each resource may have a collection of locks that are presently assigned to the resource. In the example of FIG. 4, the collection of locks for each resource may be considered a linked list of the exemplary data structures illustrated. For example, the list of locks for the backplane 110 includes the intent locks 160-180. Those of skill in the art will understand that the list of locks for each component may be registered in any number of ways, for example, pointers, tables, data arrays, etc. The lock manager 112 may query the list of locks for the resource to determine the types of locks which are currently on the resource (and may also determine lock priority as described below). In this manner, the lock manager 112 may determine if there are any current locks which conflict with the intent lock. In the exemplary embodiment of the present invention, an exclusive lock will conflict with an intent lock. Thus, if the resource on which the lock manager 112 is attempting to place an intent lock presently has an exclusive lock, the lock manager 112 may not place the intent lock on the resource and the process ends.

If on the other hand, the lock manager 112 determines that there are no conflicting locks on the resource, the process may continue to step 225 where the lock manager 112 places the intent lock on the resource. Continuing with the example from above, the lock manager in step 215 determined that the backplane 110 was not the resource to be accessed and, therefore, determined that the lock to be placed on the backplane 110 was an intent lock. In step 220, the lock manager 112 determined that there were no existing locks on the backplane 110 (as described above, at this stage in the process it should considered that intent locks 160-180 are not present on the backplane 110). Then, in step 225, the lock manager 112 placed the intent lock 160 on the backplane 110, e.g., by inserting a lock data structure into the lock list for the backplane 110.

An exemplary data structure for the intent lock 160 is shown in FIG. 4 as associated with the backplane 110. In this exemplary data structure, there is a transaction identification (TID) element, a mode (or type) of lock element, and a lock status element. The transaction identification element is an identifier which may be assigned to the transaction by the transaction manager 114. For example, the request by the SNMP module 154 to access the data object 125 may be assigned a transaction identification of 1. Each of the locks that are placed on resources for this transaction will be assigned a TID value of 1. This transaction identification may be useful for a variety of reasons. For example, when the locks for the transaction are to be cleared, the lock manager 112 may easily identify the locks to be cleared based on the TID value. In another example, when a dead lock event occurs, the lock manager may identify the locks which are associated with a particular transaction and either clear these locks for the purposes of clearing the dead lock or clear other locks that do not have a particular TID value in order that the transaction with the particular TID value may be completed. Those of skill in the art will understand that these uses are only exemplary and there are any number of other uses for the transaction value in the exemplary data structure.

The mode element of the lock identifies the type of lock which is placed on the resource. In the example of intent lock 160, the mode is intent. As previously described, the lock manager 112 may query the data structure to determine the types of locks which are currently on the resource in order to avoid locking conflicts. The lock status element indicates the status of the lock with respect to the resource (e.g., the backplane 110). In the present case, the status of intent lock 160 for the backplane 110 is granted, i.e., the intent lock 160 is currently active for the backplane 110. Other lock status indicators may include, for example, waiting, timeout, error, etc. An example of the waiting status will be described in greater detail below.

Those of skill in the art will understand that while each individual lock is associated with a particular component or data object, the data structure for these locks may be maintained by the lock manager 112. The lock manager 112 may maintain the list of locks on a component (or data object) basis and/or a transaction basis. In addition to the data described above, other exemplary data which may be contained in the various data structures for managing the locks may include pointers for the linked list of queued locks for an object, semaphores for controlling the addition and deletion of the locks, the number of locks for each resource, the number of times a transaction locked a resource, etc. The order of the locks in the lock list may be such that the lock manager may determine the priority of the locks which may be waiting to become active.

Referring back to FIG. 3, the process then continues back to step 215 to determine if the next resource is the resource to be accessed. The next resource would be the child resource of the previously locked resource which is on the path to the resource to be accessed. In the present example, the next resource is the handler 120 which is not the resource to be accessed. Thus, the process would go through the steps 220 and 225 again, which would result in the intent lock 161 being placed on the handler 120 as shown in FIG. 2 by inserting the data structure for the intent lock 161 into the lock list for handler 120 as shown in FIG. 4. The process would then continue back to step 215 for the next resource. In the present example, the next resource is the table 122 which is not the resource to be accessed. Thus, the process would go through the steps 220 and 225 again, which would result in the intent lock 162 being placed on the table 122 as shown in FIG. 2 by inserting the data structure for the intent lock 162 into the lock list for the table 122 as shown in FIG. 4. As can be seen from the exemplary data structures, each of the intent locks 160-162 have the same TID value of 1 indicating that the locks are associated with the same transaction.

On the next return to the step 215, the next resource is the data object 125 which is the resource to be accessed. As a result, the process continues to step 230 where it is determined if the resource to be accessed has any conflicting locks. The step 230 is similar to step 220 previously described above. The lock manager 112 may query the lock data structure of the resource to be accessed to determine if there are any conflicting locks presently on the resource. Since the resource to be locked is the resource to be accessed, the lock manager will be attempting to place a shared lock or an exclusive lock on the resource.

In the exemplary embodiment of the present invention a shared lock is compatible with another shared lock and with an intent lock, but is not compatible with an exclusive lock. For example, if the resource currently has a shared lock and/or an intent lock, the lock manager 112 may place a shared lock on the resource. However, if the resource currently has an exclusive lock, the lock manager may not place a shared lock on the resource. An exclusive lock is not compatible with any other type of lock, including another exclusive lock. Thus, if the lock manager 112 is attempting to place an exclusive lock on the resource, the resource must be free from any other locks.

If, in step 230, it is determined that the lock that is to be placed on the resource does not have any conflicts with existing locks, the process continues to step 240 where the lock manager 112 places the appropriate lock on the resource, e.g., by inserting the instance of the lock data structure for the lock. The lock manager 112 may then report the locking of the resources to the transaction manager 114 which may allow the consumer component access to the particular resource.

If, in step 230, it is determined that there is a conflict between the lock that is to be placed on the resource and an existing lock, the process continues to step 235 where there is a block on the placing of the lock on the resource. In this instance, the process 200 does not end as described for step 220, when an intent lock cannot be placed on one of the parent resources. Instead, the lock manager 112 places the lock in the lock list for the resource, but the lock is not granted until the conflicting locks have been cleared. The data structure for the lock 183 in FIG. 4 illustrates a lock which has a status of waiting. An example for placing the lock 183 will be described in greater detail below. When the conflicting locks have been cleared (e.g., lock 173 in the present example), the lock manager 112 changes the status of the pending lock to granted in step 240 and the resource is locked. Again, the lock manager 112 may then report the locking of the resources to the transaction manager 114 which may allow the consumer component access to the particular resource.

To complete the example started above of the SNMP module 154 attempting a read access for the data object 125, the backplane 110 has the intent lock 150, the handler 120 has the intent lock 151 and the table 122 has the intent lock 152. The process in step 215 has determined that the next resource is the data object 125 which is the resource to be accessed and, therefore, the process continues to step 230. In step 230, the lock manager 112 determines that there are no locks presently placed on the data object 125. The lock manager then proceeds to place the shared lock 163 on the data object 125. As shown in FIG. 4, the data structure for the shared lock 163 indicates the same TID value of 1 as the intent locks 160-162, but the mode of the lock is shared. As described above, the shared lock 163 indicates that the data object 125 is locked for a read operation. The lock manager 112 may then report that the appropriate locks have been placed on the data object 125 and its parent resources 122, 120 and 110 to the transaction manager 114 which will then allow the SNMP module 154 to read the data object 125. When the SNMP module 154 has completed the read operation, the transaction manager 114 may report this to the lock manager 112 which will then clear all the locks for the particular transaction, e.g., based on the TID value.

Several additional examples and partial examples will be described to illustrate some of the features of the exemplary embodiment of the present invention. In the next example, it may be considered that the web module 152 desires write access to the data object 126. It will also be considered that the locks of the previous example remain in place while this example is occurring, i.e., locks 160-163 are present when the example begins, but not locks 170-173 and 180-183. The result of this example will be that intent locks 170-172 will be placed on the backplane 110, the handler 120 and the table 122, respectively. In addition, an exclusive lock 173 will be placed on the data object 126.

The web module 152 may request access to the data object 126 by sending a message via the consumer interface 113 to the transaction manager 114 of the backplane 110 (step 205). The transaction manager 114 will notify the lock manager 112 of the request and the lock manager 112 will identify the resources to be locked (step 210). In this example, the data object 126 and its parent resources, the backplane 110, the handler 120 and the table 122. The lock manager 112 will begin the locking process with the backplane 110. The lock manager 112 will determine that the backplane 110 is not the resource to be accessed (step 215) and then determine if the backplane 110 has any current lock which will conflict with the intent lock that the lock manager will attempt to place on the backplane 110 (step 220).

In this example, the backplane 110 has an existing intent lock 160. However, an intent lock is compatible with another intent lock and, therefore, the lock manager 112 may place a second intent lock 170 on the backplane 10. There is no theoretical limit on the number of compatible locks which may be placed on the resources. In an implemented system, the maximum number of locks per resource and for the system overall may depend on any number of physical characteristics of the system, e.g., amount of memory, processing speed, etc.

The process then continues with the lock manager 112 determining that the handler 120 is not the resource to be accessed (step 215) and that it has a current intent lock 161 which does not conflict with an additional intent lock (step 220). The lock manager 112 then places a second intent lock 171 on the handler 120 (step 225). Similarly, the process then continues with the lock manager 112 determining that the table 122 is not the resource to be accessed (step 215) and that it has a current intent lock 162 which does not conflict with an additional intent lock (step 220). The lock manager 112 then places a second intent lock 172 on the table 122 (step 225). The data structures for each instance of these intent locks are illustrated in FIG. 4. Since this transaction is separate from the previous example, the lock manager 112 has assigned a TID value of 2 for these intent locks 170-172.

Finally, the lock manager 112 checks the data object 126 and determines that it is the resource to be accessed (step 215) and determines that the data object 126 does not have any existing locks (step 230). The lock manager 112 may then place the exclusive lock 173 on the data object 126 (step 240). As described above, the exclusive lock 173 indicates that the data object 126 is locked for a write operation. The lock manager 112 may then report that the appropriate locks have been placed on the data object 126 and its parent resources 122, 120 and 110 to the transaction manager 114 which will then allow the web module 152 to write to the data object 126.

As illustrated by the above two examples, the exemplary embodiment of the present invention allows for fine locking of the system resources. Some components have multiple locks (e.g., table 122 has intent locks 162 and 172), but these locks do not interfere with each other. Thus, the SNMP module 154 may access the data object 125, while the web module 152 is simultaneously accessing the data object 126, even though these data objects 125-126 share locked parent resources. This fine locking may result from the fact that the exemplary embodiment of the present invention places the resource locks on the data within the components rather than on the kernel code. If the kernel code of the handler 120 were locked so the SNMP module 154 could access the data object 125, the web module 152 would not be able to simultaneously access the data object 126 because it would be prevented by the lock on the kernel code of the handler 120.

In a further example, it may be considered that the Telnet/CLI module 150 requests read access to the data object 126 and that the locks of the previous two examples remain in place while this example is occurring, i.e., locks 160-163 and 170-173 are present when the example begins, but not locks 180-183. The result of this example will be that intent locks 180-182 will be placed on the backplane 110, the handler 120 and the table 122, respectively. In addition, a shared lock 183 with a waiting status will be placed on the data object 126.

Similar to the processes described above, the lock manager 112 will place intent locks 180-182 on the backplane 110, the handler 120 and the table 122, respectively, for this request. When the lock manager 112 queries the data object 126, it will determine that there is currently an exclusive lock 173 placed on the data object 126. A shared lock (read lock) is not compatible with the exclusive lock 173. The process will not fail because the shared lock may be blocked until the exclusive lock 173 has cleared. In this process, the lock manager 112 places the shared lock 183 on the data object 126, but the status of the data object 126 is waiting rather than granted. The data structure for the intent locks 180-182 and the shared lock 183 is illustrated in FIG. 4 which shows an assigned TID value of 3. In addition, the status of the shared lock 183 is waiting. When the exclusive lock 173 is cleared, the status of the shared lock 183 will be changed by the lock manager 112 to granted and the Telnet/CLI module 150 may then read the data object 126. At the end of this third example, all the locks illustrated in FIGS. 2 and 4 will be present on the system 100, assuming that the access operations have not been completed by the consumer components.

The locks may be cleared in a variety of manners. For example, when the consumer component (e.g., SNMP module 154) completes its access (e.g., read operation, write operation, etc.) to the producer component, the consumer component may signal to the transaction manager 114 that the current operation has been completed. The transaction manager 114 may then relay this information to the lock manager 112, including the TID of the transaction, so that the lock manager 112 may clear all the locks associated with that particular transaction, e.g., by clearing all the lock data structures corresponding to the completed TID.

In another example, it may be considered that the web module 152 requests read access to the data object 125 and that all the locks illustrated in FIG. 2 are currently active. Similar to the process described above, the lock manager 112 will place new intent locks (not shown) on the backplane 110, the handler 120 and the table 122 for this request. When the lock manager 112 queries the data object 125, it will determine that there is currently a shared lock 163 placed on the data object 125. However, since a shared lock is compatible with another shared lock (read lock), the lock manager 112 may place a second shared lock (not shown) on the data object 125. Thus, the web module 152 and the SNMP module 154 may simultaneously read the data object 125.

In another example, it may be considered that the lock manager 112 has previously placed an exclusive lock (not shown) on the table 142. While this exclusive lock is on the table 142, the SNMP module 154 may request access to the data object 145. The lock manager 112 may place new intent locks on the backplane 110 and the handler 140. However, when the lock manager 112 queries the table 142, it will determine that there is an exclusive lock already on the table 142 which conflicts with the intent lock that the lock manager 112 is attempting to place on the table 142. In this case, the operation will fail, the lock manager 112 will not place an intent lock on the table 142 and the process will not continue down to the data object 145. The lock manager may then clear the intent locks it previously placed on the backplane 10 and the handler 140 (e.g., based on the TID value assigned to the transaction). The lock manager 112 will report the failure to the transaction manager 114. The failure will then be reported to the SNMP module 154.

As can be seen from the above examples, there are a vast number of different locking scenarios which may be handled by the exemplary embodiment of the present invention. Those of skill in the art will understand that all these scenarios are not described, but may be accomplished using the resource locking system described herein. Other variations may include where a data object is directly owned by a handler component without an intervening table, where a new handler is being added to the producer components, where an existing handler is being updated, where a single producer contains multiple handlers, where a handler contains multiple tables, etc.

A final example may be where a single transaction is attempting to access multiple resources. For example, the Telnet/CLI module 150 requests read access to the data object 136 and write access to the data object 147. This example may be of interest because the lock manager 112 may accomplish placing an exclusive lock on the data object 147 for the write operation, but the shared lock for the read operation on the data object 136 may have a status of waiting (e.g., the data object 136 currently has an exclusive lock). In this example, the transaction may be holding the data object 147 to the detriment of another transaction, but the transaction cannot be completed because it is currently denied access to the data object 136. The lock manager 112 or the transaction manager 114 may recognize this conflict and clear (or change the status to waiting) for the exclusive lock on the data object 147 so that other transactions that can be completed have access to the data object 147. When the exclusive lock on the data object 136 is cleared and the shared lock of the current transaction is granted, the status of the exclusive lock on the data object 147 for the current transaction may also be changed to granted. When this occurs, the Telnet/CLI module 150 may have the simultaneous read access to the data object 136 and write access to the data object 147.

This example illustrates the fact that the lock manager 112 may be able to manage the lock queue for each object. In the above example, the lock manager 112 was able to adjust the status of the exclusive lock for the data object 147 to prevent other transactions from waiting. In other transactions, the lock manager 112 may move locks forward in the queue. For example, data object 137 may currently have a granted shared lock and a waiting (or queued) exclusive lock. A new shared lock may be placed on the data object 137 and since this shared lock is placed after the exclusive lock, it normally would receive a waiting status to be granted after the exclusive lock has cleared. However, the lock manager 112 may recognize that even though the new shared lock is not compatible with the exclusive lock in the queue ahead of it, it is compatible with the shared lock that is currently granted. The lock manager may then move the new shared lock ahead of the waiting exclusive lock and grant access to the new shared lock so that two read operations may take place simultaneously, rather than waiting unnecessarily in the queue. Those of skill in the art will understand that a system designer may design any type of queue management based on the system requirements.

In the preceding specification, the present invention has been described with reference to specific exemplary embodiments thereof. It will, however, be evident that various modifications and changes may be made thereunto without departing from the broadest spirit and scope of the present invention as set forth in the claims that follow. The specification and drawings are accordingly to be regarded in an illustrative rather than restrictive sense.

What is claimed is:

1. A method, comprising the steps of:
identifying a path of resources, wherein a last resource in the path is to be accessed;
placing a first lock type on each of the resources in the path except the last resource; and
placing a second lock type on the last resource.

2. The method according to claim 1, further comprising the step of:
accessing the last resource after the second lock type is placed on the last resource.

3. The method according to claim 1, further comprising the step of:
clearing the locks on each of the resources in the path after the last resource is accessed.

4. The method according to claim 1, further comprising the step of:
determining, prior to placing the first lock type on each of the resources except the last resource, whether the resource has a conflicting lock.

5. The method according to claim 4, wherein the first lock type is an intent lock and the conflicting lock is an exclusive lock.

6. The method according to claim 1, further comprising the steps of:
determining, prior to placing the second lock type on the last resource, whether the last resource has a conflicting lock; and
blocking the placing of the second lock type on the last resource until the conflicting lock is cleared from the last resource.

7. The method according to claim 6, wherein the second type of lock is an exclusive lock and the conflicting lock is one of a shared lock and an intent lock.

8. The method according to claim 6, wherein the second type of lock is a shared lock and the conflicting lock is an exclusive lock.

9. The method according to claim 1, wherein the resources are configured in a hierarchical arrangement.

10. A system, comprising:
a transaction manager configured to manage access to a first resource; and
a lock manager configured to lock a set of resources, the set of resources including the first resource and parent resources of the first resource, wherein the lock manager is configured to place a first lock type on the parent resources and a second lock type on the first resource.

11. The system according to claim 10, wherein, after the lock manager locks the set of resources, the transaction manager allows a component to access the first resource.

12. The system according to claim 10, wherein the lock manager determines if each of the parent resources includes a lock type which conflicts with first lock type.

13. The system according to claim 10, wherein the lock manager determines if the first resource includes a lock type which conflicts with the second lock type and blocks the placing of the second lock type on the first resource until the conflicting lock type is removed.

14. The system according to claim 10, wherein the first resource is one of a data object, a table, a handler and a backplane.

15. The system according to claim 10, wherein the transaction manager allows a first component and a second component to simultaneously access the first resource when the lock manager places two non-conflicting locks on the first resource.

16. The system according to claim 10, wherein the first lock type is one of an intent lock, a shared lock and an exclusive lock.

17. The system according to claim 10, wherein the second lock type is one of an intent lock, a shared lock and an exclusive lock.

18. A system, comprising:
an object including data which can be accessed by a consumer component, wherein the access by the consumer component is one of a read operation and a write operation;
a handler responsible for the object; and
a backplane receiving a request from the consumer component to access the object, wherein, prior to allowing access to the object, a first lock type is placed on the backplane and the handler and a second lock type is placed on the object.

19. The system according to claim 18, further comprising:
a table which includes the object, wherein the handler, the table and the object are in a hierarchical arrangement.

20. The system according to claim 18, wherein the consumer component is one of a web browser, an SNMP module and a Telnet/CLI module.

21. The system according to claim 18, wherein the second lock type is a shared lock when the consumer component requests the read operation access to the object.

22. The system according to claim 18, wherein the second lock type is an exclusive lock when the consumer component requests the write operation access to the object.
